(19) United States
(12) Patent Application Publication
(10) Pub. No.: US 2025/0103332 A1
(43) Pub. Date: Mar. 27, 2025

(54) PROCESSING CIRCUIT FOR CNN ACCELERATION AND METHOD OF OPERATING THE PROCESSING CIRCUIT

(71) Applicant: Samsung Electronics Co., Ltd., Suwon-si (KR)

(72) Inventors: Son Ngoc PHAM, Seoul (KR); Taeweon SUH, Seoul-si (KR)

(73) Assignees: Samsung Electronics Co., Ltd., Suwon-si (KR); KOREA UNIVERSITY RESEARCH AND BUSINESS FOUNDATION, Seoul (KR)

(21) Appl. No.: 18/896,097

(22) Filed: Sep. 25, 2024

(30) Foreign Application Priority Data
Sep. 26, 2023 (KR) 10-2023-0129580
May 8, 2024 (KR) 10-2024-0060756

(51) Int. Cl. G06F 9/30

(52) U.S. Cl. CPC G06F 9/30038

(57) ABSTRACT

Provided is an operating method of a processing circuit, the method including generating a first compressed chunk including only a first valid value, generating a first mask includes a reference value at a same position as a position of the first valid value, and includes a plurality of first sub-masks, generating a second compressed chunk including only a second valid value, generating a second mask, includes a reference value at a same position as a position of the second valid value, and includes a plurality of second sub-masks, generating a valid pair position value for each of a current first sub-mask and a current second sub-mask, generating a first cumulative value corresponding to a number of reference values included in a first previous sub-mask, and generating a second cumulative value corresponding to a number of reference values included in a second previous sub-mask.

### CROSS-REFERENCE TO RELATED APPLICATION

This application is based on and claims priority under 35 U.S.C. § 119 to Korean Patent Application No. 10-2023-0129580, filed on Sep. 26, 2023, and Korean Patent Application No. 10-2024-0060756, filed on May 8, 2024, in the Korean Intellectual Property Office, the disclosure of which is incorporated by reference herein in their entirety.

### BACKGROUND

The inventive concepts relate to a processing circuit and a method of operating the processing circuit, and more particularly, to a processing circuit that is configured to detect valid pairs in units of sub-masks and thereby reduces power consumed in computation, and an operating method of the processing circuit.

Deep neural networks (DNN) have been attracting much attention in recent decades, having achieved success in various fields such as computer vision, speech recognition, and autonomous vehicles. Among them, a convolution neural network (CNN) may detect meaningful features by scanning inputs through multiple filters. A CNN exhibits excellent performance, but has a problem of high computational complexity. Accordingly, apparatuses and methods for more efficiently performing CNN calculations and reducing power and time consumed for performing the calculations are being explored.

### SUMMARY

The inventive concepts provide a processing circuit for reducing power consumption and time for operation by reducing the computational amount by more efficiently detecting pairs of valid values between two inputs in an operation of a neural network model, and an operating method of the processing circuit.

The technical objectives of the inventive concepts are not limited to those mentioned above, and other technical objectives not mentioned herein may be clearly understood by those of ordinary skill in the art from the description below.

According to an aspect of the inventive concepts, there is provided a processing circuit including a processing element (PE) configured to generate an output value corresponding to a first chunk and a second chunk that is equal in size to the first chunk, the first chunk including at least one first valid value and the second chunk including at least one second valid value; a first input circuit configured to provide, to the PE, a first compressed chunk and a first mask that is equal in size to the first chunk, the first mask including a reference value at a position corresponding to the at least one first valid value, and the first compressed chunk including the at least one first valid value; and a second input circuit configured to provide, to the PE, a second compressed chunk and a second mask that is equal in size to the second chunk, the second mask including a reference value at a position corresponding to the at least one second valid value, and the second compressed chunk the at least one second valid value, wherein the first compressed chunk does not include the at least one second valid value and the second compressed chunk does not include the at least one first valid value, wherein the first mask comprises a current first sub-mask, the second mask comprises a current second sub-mask corresponding to the current first sub-mask, and the current first sub-mask and the current second sub-mask include reference values at a same first position, and wherein the PE is further configured to generate the output value by performing an operation on a first valid value corresponding to a second position of the first compressed chunk and a second valid value corresponding to a third position of the second compressed chunk, wherein the first valid value and the second valid value are selected based on a first valid pair position value corresponding to the first position, and the first valid pair position value is less than a size of the current first sub-mask.

According to another aspect of the inventive concept, there is provided a processing circuit including a processing element (PE) configured to generate an output value corresponding to a first chunk and a second chunk that is equal in size to the first chunk, the first chunk including at least one first valid value and the second chunk including at least one second valid value; a first input circuit configured to provide, to the PE, a first compressed chunk and a first mask that is equal in size to the first chunk, the first mask including a reference value at a position corresponding to the at least one first valid value, and the first compressed chunk including the at least one first valid value; and a second input circuit configured to provide, to the PE, a second compressed chunk and a second mask that is equal in size to the second chunk, the second mask including a reference value at a position corresponding to the at least one second valid value, and the second compressed chunk including the at least one second valid value, wherein the first compressed chunk does not include the at least one second valid value and the second compressed chunk does not include the at least one first valid value, wherein the size of the first mask is equal to the size of the second mask, and wherein the PE comprises an accumulation circuit configured to generate a valid pair position value by searching for positions where reference values are commonly included in each of the first mask and the second mask in units of sub-masks which are smaller in size than the first mask and the second mask, and generate a cumulative value based on a number of reference values included in a previous region in which a search is completed, among entire regions of each of the first mask and the second mask, and wherein the PE is further configured to generate the output value by performing an operation on a first valid value and a second valid value selected based on the cumulative value and the valid pair position value.

According to another aspect of the inventive concepts, there is provided an operating method of a processing circuit, the method including generating a first compressed chunk including only at least one first valid value by compressing a first chunk including the at least one first valid value, generating a first mask that is equal to a size of the first chunk, includes a reference value at a same position as a position of the at least one first valid value, and includes a plurality of first sub-masks having a same size as each other, generating a second compressed chunk including only at least one second valid value by compressing a second chunk including the at least one second valid value, generating a second mask that is equal to a size of the second chunk, includes a reference value at a same position as a position of the at least one second valid value, and includes a plurality of second sub-masks having a same size as each other, generating a valid pair position value by searching for a valid pair position including corresponding reference values at a same position of each of a current first sub-mask and a current second sub-mask corresponding to each other, generating a first cumulative value corresponding to a number of reference values included in at least one first previous sub-mask located before the current first sub-mask, and generating a second cumulative value corresponding to a number of reference values included in at least one second previous sub-mask located before the current second sub-mask.

### BRIEF DESCRIPTION OF THE DRAWINGS

Embodiments will be more clearly understood from the following detailed description taken in conjunction with the accompanying drawings in which:

FIG. 1 is a block diagram illustrating a processing circuit according to at least one embodiment;

FIG. 2 is a block diagram illustrating a processing element (PE) according to at least one embodiment;

FIG. 3 is a diagram for describing a data compression method according to at least one embodiment;

FIG. 4 is a diagram for describing an operation of detecting a valid pair, according to at least one embodiment;

FIG. 5 is a diagram for describing an operation of detecting a valid pair, according to at least one embodiment;

FIG. 6 is a diagram for describing a convolution calculation operation, according to at least one embodiment;

FIGS. 7A to 7C are diagrams for describing a data flow according to at least one embodiment;

FIG. 8 is a flowchart showing a method of operating a processing circuit, according to at least one embodiment;

FIG. 9 is a block diagram illustrating a computing system according to at least one embodiment; and

FIG. 10 is a block diagram illustrating a portable computing device according to at least one embodiment.

### DETAILED DESCRIPTION OF THE EMBODIMENTS

Hereinafter, various embodiments are described with reference to the accompanying drawings. It will be understood that although terms such as “first” and “second” may be used herein to describe various components, these components should not be limited by these terms. These terms are only used to distinguish one element from another.

In the disclosure, terms such as “device”, “element” or “unit” may be used to denote a unit that has at least one function or operation and is implemented with processing circuitry, such as hardware, software, or a combination of hardware and software. For example, the processing circuitry more specifically may include, but is not limited to, a central processing unit (CPU), an arithmetic logic unit (ALU), a digital signal processor, a microcomputer, a field programmable gate array (FPGA), a System-on-Chip (SoC), a programmable logic unit, a microprocessor, application-specific integrated circuit (ASIC), etc. The processing circuitry may include electrical components such as at least one of transistors, resistors, capacitors, etc., and/or electronic circuits including said components.

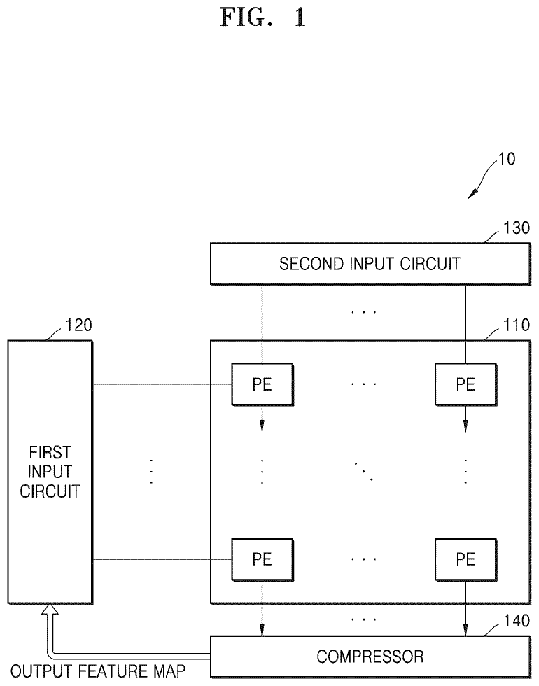

FIG. 1 is a block diagram illustrating a processing circuit according to at least one embodiment.

Referring to FIG. 1, a processing circuit 10 may include a processing element (PE) array, a first input circuit 120, a second input circuit 130, and a compressor 140.

The PE array 110 may include a plurality of PEs arranged in a matrix form. Additionally, in some embodiments, the PE array 110 may be referred to as a systolic array, and the processing circuit 10 may be referred to as an accelerator.

The first input circuit 120 may output first input data to a corresponding PE. For example, the first input data may be an input feature map used in a convolution operation. Hereinafter, for convenience of description, an operation according to the operation of the processing circuit 10 according to the inventive concepts is described on the assumption that the operation is a convolution operation, but the inventive concepts are not limited thereto, and it will be obvious to those skilled in the art that the computational complexity may be reduced based on an operation of the processing circuit 10 according to the inventive concepts. In at least one embodiment, an input feature map may be understood as an output feature map of a previous layer in a neural network.

In at least one embodiment, the first input circuit 120 may provide the same input feature map to a plurality of PEs (may be referred to as a PE cluster) located in the same row among a plurality of PEs included in the PE array 110, and the second input circuit 130, which is described later, may provide the same weight map to a plurality of PEs located in the same column among a plurality of PEs included in the PE array 110. Accordingly, in at least one embodiment, a plurality of PEs in the same row may generate output features for consecutive output channels, and a plurality of PEs in the same column may generate output features of the same output channel.

The second input circuit 130 may output second input data to a corresponding PE. For example, the second input data may be a weight map used in a convolution operation.

Each of the plurality of PEs may perform an operation based on first input data and second input data respectively received from the first input circuit 120 and the second input circuit 130. The plurality of PEs may transmit an operation result to respective PEs located in the same column, and the PE that has received the operation result may add its own operation result and the received operation result. For example, the processing circuit 10 may receive an input feature map and a weight map as input values based on a plurality of PEs, and perform a multiplication and accumulation (MAC) operation on the input feature map and the weight map to generate an output feature map as an output value.

According to at least one embodiment, the processing circuit 10 may store values of the weight map in the PE array 110 and reuse the values of the weight map even after one MAC operation. That is, the processing circuit 10 may receive only an input feature map as an input value and perform a MAC operation on the input feature map and the values of the weight map stored in the PE array 110 to output an output feature map as an output value. Storing of the values of the weight map in the PE array 110 may be referred to as preloading of the values of the weight map in a systolic array. Additionally, the MAC operation may refer to an operation of multiplying two input values and then accumulating results thereof. A MAC operation is a type of an operation used in machine learning and signal processing algorithms such as neural networks, and may be particularly widely used in neural network structures such as convolutional neural networks (CNN).

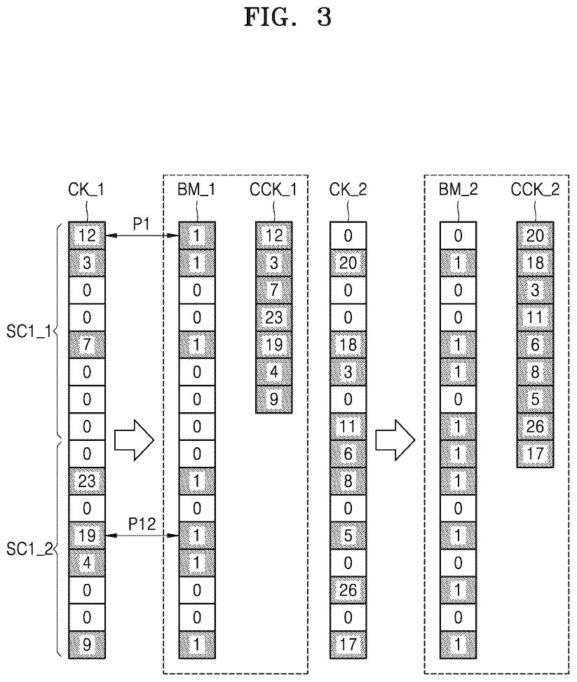

The compressor 140 may compress an output feature map OUTPUT FEATURE MAP output from the PE array 110 and transmit the same to the first input circuit 120. The compressor 140 may be referred to as a compression circuit. The output feature map OUTPUT FEATURE MAP may include at least one valid value and at least one invalid value (referred to as a non-valid value). The compressor 140 may generate a compressed feature map by removing invalid values included in the output feature map OUTPUT FEATURE MAP. The output feature map OUTPUT FEATURE MAP shown in FIG. 1 may refer to a compressed feature map compressed by the compressor 140. For example, the compressor 140 may compress the output feature map OUTPUT FEATURE MAP by using zero value compression (ZVC). Details regarding compression according to the ZVC method will be described later with reference to FIG. 3.

The sparsity inherent in an input of a CNN may offer the potential to significantly reduce computational workload. Hereinafter, sparsity may be referred to as an invalid value. The processing circuit 10 according to the inventive concepts may reduce the computational complexity consumed in a CNN by improving utilization of invalid values included in each of two inputs (e.g., an input feature map and a weight map).

Each of the plurality of PEs included in the PE array 110 according to the inventive concepts may detect a position of a pair of valid values included in two inputs and perform an operation based on the pair of valid values, thereby reducing the amount of calculation and improving power efficiency and throughput. Details regarding valid values, invalid values, and pairs of valid values are described later with reference to FIGS. 3 to 5.

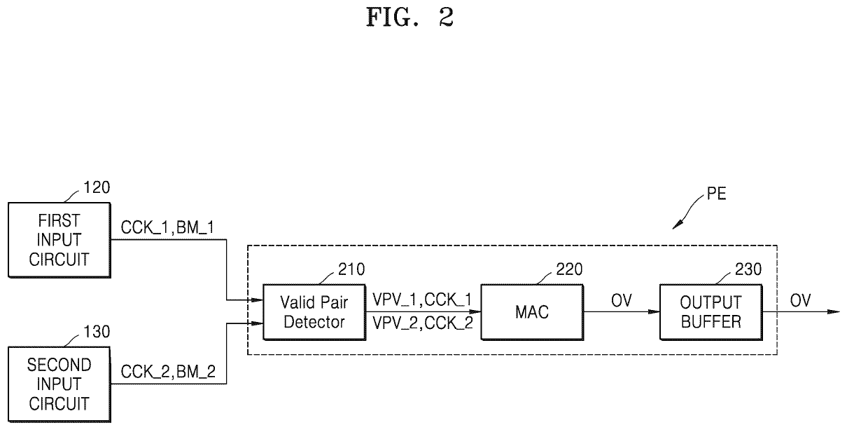

FIG. 2 is a block diagram illustrating a PE according to at least one embodiment.

The PE according to the inventive concepts may include a valid pair detector 210, a MAC 220, and an output buffer 230.

As described above with reference to FIG. 1, the PE may receive an input (e.g., an input feature map and a weight map) from each of the first input circuit 120 and the second input circuit 130.

In the inventive concepts, a chunk refers to a result of dividing, by an N-sized vector, an input feature map and a weight map provided to the PE by each of the first input circuit 120 and the second input circuit 130 described above with reference to FIG. 1.

Hereinafter, the input feature map and the weight map will be described based on chunks. For example, a portion of each of the input feature map and the weight map corresponding to one PE among values included in the input feature map and the weight map described above may be referred to as one chunk, and a feature map compressed by the compression described above with reference to FIG. 1 may be referred to as a compressed chunk. This may be easily understood by referring to FIGS. 3 to 5.

Referring to FIG. 2, a PE according to at least one example of the inventive concepts may receive a first compressed chunk CCK_1 and a first bit mask BM_1 from the first input circuit 120. As described above, a compressed chunk may refer to a chunk that is compressed using a valid value included in the chunk. For example, the first compressed chunk CCK_1 may be a chunk which is included in the input feature map and includes N vectors corresponding to one PE, the chunk being compressed using the ZVC method described above. In the inventive concepts, a bit mask may indicate a position of valid values included in a chunk that is not yet compressed chunk. In the inventive concepts, a bit mask may be referred to as a mask, for convenience of description. Details regarding compressed chunks and bit masks are described later with reference to FIGS. 3 to 5.

Referring further to FIG. 2, the PE according to the inventive concepts may receive a second compressed chunk CCK_2 and a second bit mask BM_2 from the second input circuit 130. For example, the second compressed chunk CCK_2 may be a chunk which is included in the weight map and compressed using the ZVC method, and the second bit mask BM_2 may indicate positions of valid values included in the chunk before being compressed. Hereinafter, in the inventive concepts, a bit mask is referred to as a mask, for convenience of description.

The valid pair detector 210 according to the inventive concepts may detect a valid pair based on the first mask BM_1 and the second mask BM_2. The valid pair detector 210 may compare the first mask BM_1 and the second mask BM_2 that correspond to each other, and when values at the same positions of the first mask BM_1 and the second mask BM_2 are determined as valid, the valid pair detector 210 may detect a valid pair at the above position. The valid pair detector 210 according to the inventive concepts may determine, based on a valid pair position value, a position of a valid value included in the first compressed chunk CCK_1 and to be used for calculation (that is, a first valid position value VPV_1) and transmit the first valid position value VPV_1 to the MAC 220 along with the first compressed chunk CCK_1. Similarly, the valid pair detector 210 according to the inventive concepts may determine, based on a valid pair position value, a position of a valid value included in the second compressed chunk CCK_2 and to be used for calculation (that is, a second valid position value VPV_2) and transmit the second valid position value VPV_2 to the MAC 220 along with the second compressed chunk CCK_2.

The MAC 220 according to the inventive concepts may perform an efficient operation based on the first compressed chunk CCK_1, the second compressed chunk CCK_2, the first valid position value VPV_1, and the second valid position value VPV_2 which are received from the valid pair detector 210. The MAC 220 may perform an operation based only on valid values corresponding to valid pairs based on the first compressed chunk CCK_1, the second compressed chunk CCK_2, the first valid position value VPV_1, and the second valid position value VPV_2 to perform an operation on all valid values, thereby reducing the amount of calculation, and reducing also overhead consumed in detecting the valid pairs.

The MAC 220 may include components for performing operations of a CNN. For example, the MAC 220 may include a multiplier (or multiplication circuit), and an accumulator. The multiplier may be an 8-bit multiplier that performs multiplication of valid values included in a chunk. Additionally, the accumulator may be a 24-bit accumulator, and output an accumulation result to the output buffer 230 to generate a partial total. Additionally, the MAC 220 may further include two buffers configured to buffer the first compressed chunk CCK_1 and the second compressed chunk CCK_2.

The MAC 220 according to the inventive concepts may generate an output value OV based on the first compressed chunk CCK_1, the second compressed chunk CCK_2, the first valid position value VPV_1, and the second valid position value VPV_2 received from the valid pair detector 210, and output the output value OV to the output buffer 230.

The output buffer 230 may store the output value OV. A size of the output buffer 230 according to at least one embodiment may be determined based on experimental results of various CNN models in order to equally divide an output channel dimension among a plurality of PEs. For example, the output buffer 230 may be a 24-bit output buffer having a size of 14×14 elements. However, the above-described examples are intended to help understanding of the inventive concepts, and the inventive concepts are not limited thereto.

Although not shown for convenience of description, a PE may further include a finite state machine (FSM) controller. The FSM controller may automatically coordinate the operation of the PE while receiving input data and information such as the number and strides of assigned output functions. Additionally, data stored in an input buffer may be reused to generate any possible output.

FIG. 3 is a diagram for describing a data compression method according to at least one embodiment.

The data compression method of FIG. 3 may be performed through the operation of the compressor (140 in FIG. 1) described above with reference to FIG. 1. The compression method described later with reference to FIG. 3 is a description of a ZVC compression method. However, the compression method according to the inventive concepts is not limited thereto, and it will be understood that the method may be used for any compression method of compressing, only using valid values, chunks (or feature maps, etc.) including valid values and invalid values, and generating masks indicating the positions of valid values.

Referring to FIG. 3, compression of the first chunk CK_1 and the second chunk CK_2 according to the ZVC method will be described. Each of the first chunk CK_1 and the second chunk CK_2 may be understood as N (N is an integer of 1 or more) vectors included in the input feature map and the weight map described above with reference to FIGS. 1 and 2. Vectors (hereinafter referred to as values) included in each of the first chunk CK_1 and the second chunk CK_2 shown in FIG. 3 are examples to help understanding, and the inventive concepts is not limited thereto.

Referring to FIG. 3, each of the first chunk CK_1 and the second chunk CK_2 may include valid values and invalid values. Invalid values refer to sparsity, as described above. The invalid values included in each of the first chunk CK_1 and the second chunk CK_2 are expressed as 0, and the valid values are expressed as integers other than 0.

Two values at the same positions, included in each of the first chunk CK_1 and the second chunk CK_2, may be multiplied during a convolution operation. Therefore, if at least one of two corresponding values is an invalid value (e.g., 0), the multiplication operation may not be valid in a final output value. Therefore, this may be understood as an unnecessary operation process, and the unnecessary operation process may therefore be omitted. In other words, performing only valid operations on the final output value is a method to reduce the amount of computation while maintaining the accuracy of the convolution operation, thereby increasing the efficiency of the convolution operations and reducing power and time consumed for performing the convolution operations. Hereinafter, in order to distinguish the valid values included in each of the first chunk CK_1 and the second chunk CK_2 from each other, a valid value included in the first chunk CK_1 is referred to as a first valid value, and a valid value included in the second chunk CK_2 is referred to as a second valid value.

The first chunk CK_1 may be compressed into a first compressed chunk CCK_1 according to, e.g., the zero-value compression (ZVC) method. The first mask BM_1 may include information about a position of a valid value included in the first chunk CK_1. The first mask BM_1 may include position information of the valid value included in the first chunk CK_1, by including a reference value at the same position as a position of the valid value included in the first chunk CK_1. A reference value is displayed as 1 in the first mask BM_1 of FIG. 3. An invalid value (e.g., 0) included in the first chunk CK_1 is displayed as 0 in the first mask BM_1. For example, the first chunk CK_1 may include a valid value (e.g., 12) at a first position P1, and to correspond to this, the first mask BM_1 may include a reference value at the first position P1 thereof. The first chunk CK_1 may include a valid value (e.g., 19) at a twelfth position P12, and to correspond to this, a reference value may be included at the twelfth position P12 of the first mask BM_1. It will be understood that the first position P1 and the twelfth position P12 shown in FIG. 3 are positions where valid or invalid values included in the first chunk CK_1 and the first mask BM_1 are counted sequentially from the top and are provided as an example, but that the examples are not limited thereto. Based on this, positions of reference values included in the first mask BM_1 and positions of reference values included in the second mask BM_2 may be understood.

Each of the first compressed chunk CCK_1 and the second compressed chunk CCK_2 includes only valid values included in each of the first chunk CK_1 and the second chunk CK_2. Valid values included in each of the first compressed chunk CCK_1 and the second compressed chunk CCK_2 are included while maintaining the positional order in each of the first chunk CK_1 and the second chunk CK_2.

In FIG. 3, for convenience of description, a size of each of the first chunk CK_1 and the second chunk CK_2 is shown as 16 (e.g., the number of valid values and invalid values included in each is 16), but the inventive concepts is not limited thereto, and the size of a chunk may be set differently according to the specifications of the PE or the number of PEs included in a pixel array. For example, the size of a chunk may be 128. For example, the size of the first chunk CK_1 may be the same as the size of the second chunk CK_2. However, the inventive concepts are not limited thereto.

A chunk may include multiple sub-chunks with the same size. Referring to FIG. 3, the size of the first chunk CK_1 may be 16, and the first chunk CK_1 may include two first sub-chunks SC1_1 and SC1_2. The size of each of the first sub-chunks SC1_1 and SC1_2 may be 8. As described above, the size of a chunk and the size of a mask may be the same, and similarly, a mask may include a sub-mask of the same size as that of a sub-chunk. For example, referring to FIG. 3, the first mask BM_1 may include two sub-masks of a size of 8.

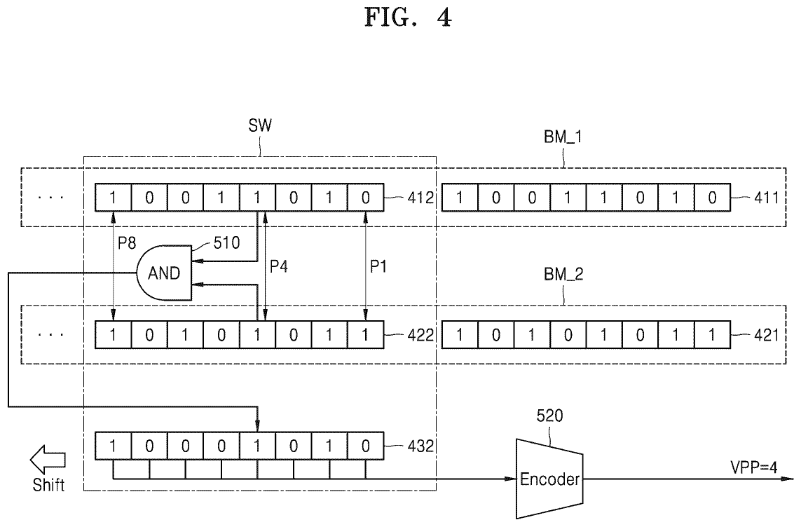

FIG. 4 is a diagram for describing an operation of detecting a valid pair, according to at least one embodiment.

While a compressed chunk (e.g., CCK_1) and a mask (e.g., BM_1) shown in FIGS. 4 to 6 described later are illustrated as being basically the same as the chunk, compressed chunk, and the mask according to the example described above with reference to FIG. 3 for convenience of description, the inventive concepts is not limited thereto. Additionally, chunks, compressed chunks, and masks may be described later differently from FIG. 3 as needed.

FIG. 4 is a diagram for describing a valid pair detection operation of a PE described above with reference to FIG. 2. In detail, FIG. 4 is a diagram for describing an operation of the valid pair detector (210 in FIG. 2) included in the PE according to the inventive concepts.

As described above, the PE may receive a first compressed chunk (CCK_1 in FIG. 2), a second compressed chunk (CCK_2 in FIG. 2), the first mask BM_1, and the second mask BM_2 from the first input circuit (120 in FIG. 2) and the second input circuit (130 in FIG. 2).

Referring to FIG. 4, the processing circuit (10 in FIG. 1) according to the inventive concepts may compare reference values at the same positions included in each of the first mask BM_1 and the second mask BM_2. The processing circuit (10 in FIG. 1) may compare reference values at the same positions of the first mask BM_1 and the second mask BM_2 included in a search window SW.

As described above, a mask may include a plurality of sub-masks having the same size. Referring to FIG. 3, the first mask BM_1 may include first sub-masks 411 and 412 having the same size (e.g., 8). Similarly, the second mask BM_2 may include second sub-masks 421 and 422 having the same size (e.g., 8). Unlike the description provided with reference to FIG. 3, the sizes of the first mask BM_1 and the second mask BM_2 may be greater than 16. For example, the sizes of the first mask BM_1 and the second mask BM_2 may be 128, respectively. Accordingly, the first mask BM_1 may further include a first sub-mask (not shown) that is continuous to the first sub-mask 412. Similarly, the second mask BM_2 may further include a second sub-mask (not shown) that is continuous to the second sub-mask 422. Referring to FIG. 3, the first sub-mask 412 and the second sub-mask 422 may correspond to the search window SW at a current time. Each of the first sub-mask 412 and the second sub-mask 422 corresponding to the search window SW is referred to as a current sub-mask.

The search window SW according to the inventive concepts may be shifted to the right in FIG. 4 when detection of a valid pair for the current sub-masks (412 and 422 in FIG. 4) is completed. Sub-masks for which valid pair detection has been completed with respect to the current sub-masks (412 and 422 in FIG. 4) are referred to as previous sub-masks (411 and 421 in FIG. 4). Conversely, a sub-mask for which valid pair detection has not started is referred to as a next sub-mask (not shown).

The size of the search window SW according to the inventive concepts may be the same as the size of the sub-mask (412 and 422 in FIG. 4). The processing circuit 10 according to the inventive concepts may detect a valid pair by searching reference values of the current sub-mask (412 and 422 in FIG. 4) corresponding to the search window SW in position order. Referring to FIG. 3, the processing circuit 10 may determine whether a reference value is included at the first position P1 of each of the first sub-mask 412 and the second sub-mask 422 corresponding to the search window SW to detect a valid pair. Referring to FIG. 3, valid pair detection may be performed from right to left. Accordingly, valid pair detection may be performed sequentially from the first position P1 to an eighth position P8.

As described above, the processing circuit 10 may perform a valid pair detection operation. The processing circuit 10 according to the inventive concepts may detect a position where a reference value is included in both the first sub-mask 412 and the second sub-mask 422. For example, as a reference value is included at a fourth position P4 of the first sub-mask 412 and a reference value is included at a fourth position P4 of the second sub-mask 422, the processing circuit 10 may detect a valid pair from the fourth position P4. The processing circuit (10 in FIG. 1) may include an AND circuit 510, and based on the AND circuit 510, the processing circuit 10 may determine whether reference values are at the same positions in both the first sub-mask 412 and the second sub-mask 422. As described above, a valid pair set 432 indicating the positions of valid pairs according to the first sub-mask 412 and the second sub-mask 422 of FIG. 3 may be generated.

The processing circuit (10 in FIG. 1) according to the inventive concepts may further include an encoder 520. The encoder 520 according to the inventive concepts may encode an output of the AND circuit 510. The encoder 520 may generate a valid pair position value VPP by encoding information about positions of valid pairs compared in the search window SW. For example, the encoder 520 may generate the valid pair position value VPP based on the valid pair set 432. For example, referring to FIG. 3, in the processing circuit (10 in FIG. 1) according to the inventive concepts, the valid pair position value VPP corresponding to the fourth position P4 corresponding to the position of the valid pair may be 4. The encoder 520 may be a priority encoder.

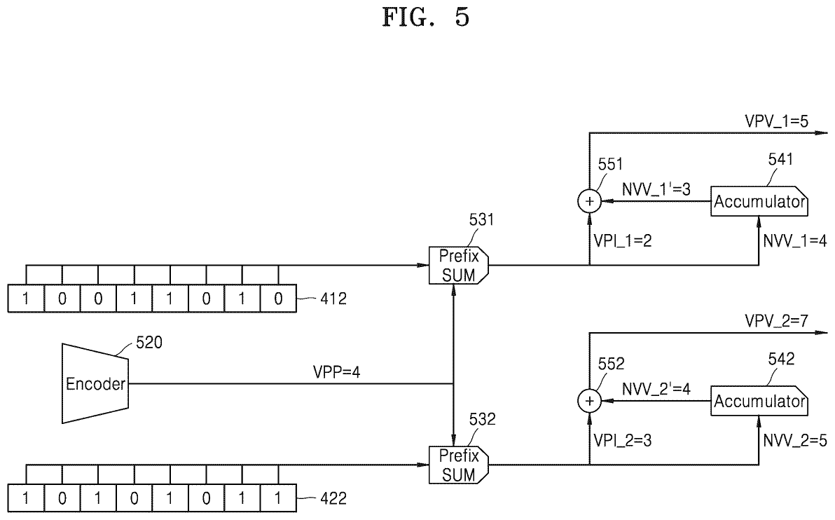

FIG. 5 is a diagram for describing an operation of detecting a valid pair, according to at least one embodiment.

FIG. 5 may be described later with reference to the description provided with reference to FIG. 4.

As described above with reference to FIG. 4, the encoder 520 may generate a valid pair position value VPP. According to the embodiment described above with reference to FIG. 4, the valid pair position value VPP may be 4. FIG. 5 will be described later on the assumption of the description provided with reference to FIG. 4.

Referring to FIG. 5, the processing circuit (10 in FIG. 1) according to the inventive concepts may include a first section sum circuit 531 and a second section sum circuit 532. The first section sum circuit 531 may receive the valid pair position value VPP, and determine which reference value of a position corresponding to the valid pair position value VPP is from among reference values included in the first sub-mask 412 and generate a first valid position information value VPI_1. Referring to FIG. 5, among the reference values included in the first sub-mask 412, a reference value corresponding to the valid pair position value (VPP=4) is a second reference value, so the first valid position information value VPI_1 is 2.

The first section sum circuit 531 according to the inventive concepts may count the number of reference values included in the first sub-mask 412 and generate a first number of valid values NVV_1. Since the number of reference values included in the first sub-mask 412 is 4, the first number of valid values NVV_1 is 4.

The first section sum circuit 531 may transmit the first valid position information value VPI_1 to a first adder circuit 551 and the first number of valid values NVV_1 to a first accumulator 541. In the present disclosure, the accumulator (e.g., 541) may be referred to as an accumulation circuit, and may mean a circuit for accumulating the number of valid values (e.g., NVV_1) sequentially received from the section sum circuit (e.g., 531).

The first accumulator 541 may store a first cumulative value NVV_1′ corresponding to the number of reference values included in the previous sub-mask, and may transmit the first cumulative value NVV_1′ to the first adder circuit 551. For example, referring to FIG. 4, the number of reference values included in the previous first sub-mask 411, that is, the number of valid values, is 3, and thus the first cumulative value NVV_1′ is 3 and the first accumulator 541 may store the first accumulated value NVV_1′ and transmit the same to the first adder circuit 551.

Referring further to FIGS. 4 and 5 together, when the valid pair search for the current first sub-mask 412 and the current second sub-mask 422 is completed (e.g., when a valid pair search for a last position of each of the current first sub-mask 412 and the current second sub-mask 422 is completed) the first accumulator 541 may accumulate the first cumulative value NVV_1′ and the number of first valid values NVV_1 and update the first cumulative value NVV_1′. For example, in a valid pair search operation for a next first sub-mask and a next second sub-mask, the first cumulative value NVV_1′ is 7.

The operation and role of the second section sum circuit 532 and the second valid position information value VPI_2 according to the inventive concepts may be understood through FIG. 5 and the above description. For example, referring to FIG. 5, among the reference values included in the second sub-mask 422, a reference value corresponding to the valid pair position value (VPP=4) is a third reference value, so the second valid position information value VPI_2 is 3. Additionally, a number of second valid values NVV_2 is 5. In addition, the second section sum circuit 532 may transmit the second valid position information value VPI_2 to a second adder circuit 552 and transfers the number of second valid values NVV_2 to a second accumulator 542.

Referring to FIGS. 4 and 5 together, when the valid pair search for the current first sub-mask 412 and the current second sub-mask 422 is completed (e.g., when a valid pair search for a last position of each of the current first sub-mask 412 and the current second sub-mask 422 is completed) the second accumulator 542 may accumulate the second cumulative value NVV_2′ and the number of second valid values NVV_2 to update the second cumulative value NVV_2′. For example, in a valid pair search operation for a next first sub-mask and a next second sub-mask, the second cumulative value NVV_2′ is 7.

The first adder circuit 551 according to the inventive concepts may generate the first valid position value VPV_1 by adding the first valid position information value VPI_1 and the first cumulative value NVV_1′. Referring to the above-described example, the first valid position value VPV_1 is 5. Similarly, the second adder circuit 552 may generate the second valid position value VPV_2 by adding the second valid position information value VPI_2 and the second cumulative value NVV_2′. Referring to the above-described example, the second valid position value VPV_2 is 7.

The processing circuit (10 in FIG. 1) according to the inventive concepts may include the first adder circuit 551, the second adder circuit 552, the first accumulator 541, and the second accumulator 542. In detail, the PE according to the inventive concepts may include the first adder circuit 551, the second adder circuit 552, the first accumulator 541, and the second accumulator 542. For convenience of description, the first adder circuit 551 and the second adder circuit 552 are illustrated, but the first adder circuit 551 and the second adder circuit 552 may be implemented as a single adder circuit, and the first accumulator 541 and the second accumulator 542 may be implemented as a single accumulation circuit.

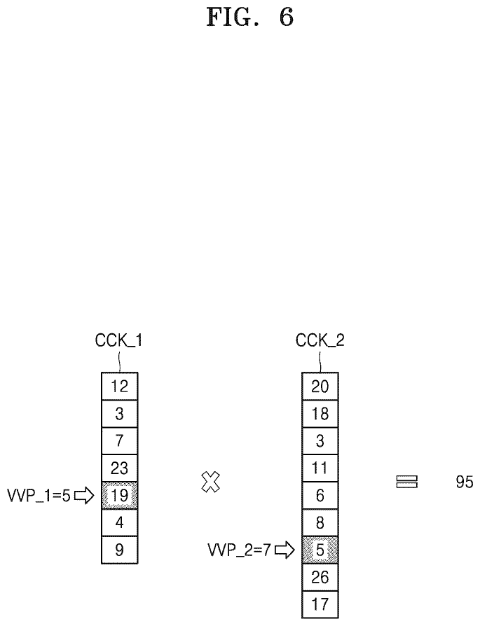

FIG. 6 is a diagram for describing a convolution calculation operation, according to at least one embodiment.

FIG. 6 may be described later based on the details described above with reference to FIGS. 4 and 5.

Referring to FIG. 6, based on the first valid position value VVP_1 and the second valid position value VVP_2 described above with reference to FIG. 5, the processing circuit (10 in FIG. 1) according to the inventive concepts may perform an operation by selecting respective valid values included in the first compressed chunk CCK_1 and the second compressed chunk CCK_2. Referring to FIG. 6, the first valid position value VVP_1 is 5 and the second valid position value VVP_2 is 7, and thus, the processing circuit (10 in FIG. 1) according to the inventive concepts may perform an operation based on a first valid value included at a fifth position of the first compressed chunk CCK_1 (e.g., 19) (since the first valid position value VVP_1 is 5) and a second valid value included at a seventh position (the second valid position value VVP_2 is 7) of the second compressed chunk CCK_2 (e.g., 5). If the given operation is a convolution operation, the processing circuit (10 in FIG. 1) may generate a calculated value by multiplying the first valid value (e.g., 19) by the second valid value (e.g., 5).

The processing circuit (10 in FIG. 1) according to the inventive concepts may perform the above-described process with reference to FIGS. 1 to 6 by using the first mask (BM_1 in FIG. 4), the second mask (BM_2 in FIG. 4), and the first compressed chunk CCK_1 and the second compressed chunk CCK_2, and may generate an output value by adding at least one calculation value calculated accordingly. As described above with reference to FIG. 1, the processing circuit (10 in FIG. 1) according to the inventive concepts may perform an operation on the input feature map and the weight map based on a plurality of PEs, and the above-described output value may constitute the output feature map of FIG. 1 (OUTPUT FEATURE MAP in FIG. 1).

As described above, as the processing circuit (10 in FIG. 1) according to the inventive concepts includes an adder circuit (551 and 552 in FIG. 5) and an accumulation circuit (541 and 542 in FIG. 5), an operation may be performed only on valid pairs. Accordingly, the amount of calculation may be reduced by not performing unnecessary calculations.

In addition, as the processing circuit (10 in FIG. 1) according to the inventive concepts includes an adder circuit (551 and 552 in FIG. 5) and an accumulation circuit (541 and 542 in FIG. 5) as described above, power consumption and hardware resource utilization for calculating the first valid position value VPV_1 (FIG. 5) and the second valid position value VPV_2 may be reduced. Compared to when an adder circuit (551 and 552 in FIG. 5) and an accumulation circuit (541 and 542 in FIG. 5) are not included, power and hardware resources consumed by the encoder (520 in FIG. 4) to encode the positions of the valid pairs may be reduced.

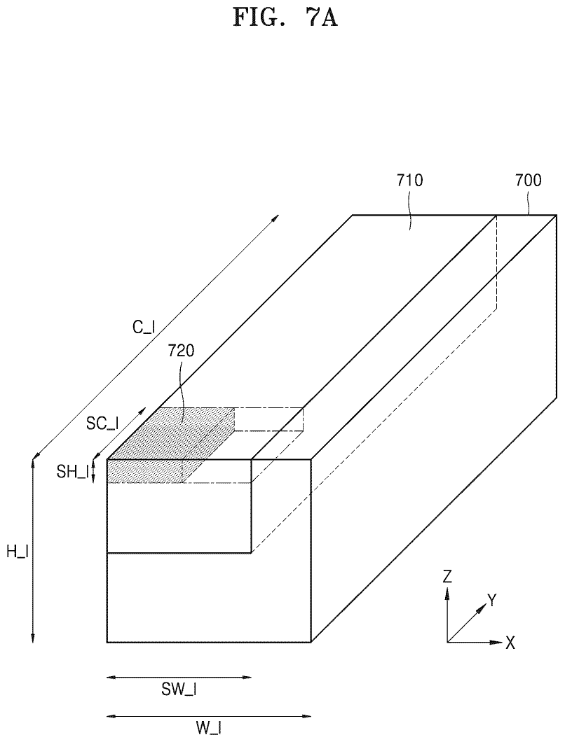

FIGS. 7A to 7C are diagrams for describing a data flow according to at least one embodiment.

With reference to FIGS. 7A to 7C, a local data flow of a PE and a data flow for more efficiently performing temporal data reuse will be described later.

FIGS. 7A, 7B, and 7C each illustrate an input feature map 700, a weight map 800, and an output feature map 900 described above. Each map has a width in a first direction (X direction), a channel in a second direction (Y direction) perpendicular to the first direction, and a height in a third direction (Z direction) perpendicular to both the first direction and the second direction.

Referring to FIG. 7A, a size of the input feature map 700 may be W_I×H_I×C_I, and may include a sub-input feature map 710. A size of the sub-input feature map 710 is SW_I×SH_I×SC_I. The sub-input feature map 710 may include an input selection window 720.

Referring to FIG. 7B, a size of the weight map 800 may be W_F×H_F×C_F and include a sub-weight map 810. A size of the sub-weight map 810 is W_F×SH_F×SC_F. The sub-weight map 810 may include a weight selection window 820.

Referring to FIG. 7C, a size of the output feature map 900 is W_O×H_O×1, and the output feature map 900 may include a sub-output feature map 910. A size of the sub-output feature map 910 may be SW_O×SH_O×1, and the sub-output feature map 910 may include an output value 920 generated through a convolution operation between the input selection window 720 and the weight selection window 820 described above.

The processing circuit (10 in FIG. 1) according to the inventive concepts may divide each of the input feature map 700 and the weight map 800 into the input selection window 720 and the weight selection window 820 as described above in order to more efficiently manage a data flow. This is because the size of an input buffer is limited.

The processing circuit (10 in FIG. 1) according to the inventive concepts may load the sub-input feature map 710 and the sub-weight map 810 into a buffer included in the PE. The processing circuit (10 in FIG. 1) may generate one output value by selecting sub-sections included in each of the sub-input feature map 710 and sub-weight map 810 buffered in the PE. The sub-sections included in each of the sub-input feature map 710 and the sub-weight map 810 and selected may be the input selection window 720 and the weight selection window 820.

When operations on the input selection window 720 and the weight selection window 820 that are selected are completed, the input selection window 720 may be shifted in the second direction by a preset stride (first operation).

In the above-described process, the first operation may be repeated in the second direction until an end of the locally buffered sub-input feature map 710. Thereafter, the weight selection window 820 may be shifted by a preset stride in an opposite direction to the third direction (second operation) to repeat the first operation described above. The above operation may be repeated until an end of the sub-weight map 810 in an opposite direction to the third direction.

Thereafter, the sub-input feature map 710 is flushed and replaced with another sub-input feature map (710 shifted in the opposite direction to the third direction) of the same size as that of the flushed sub-input feature map. The above-described operation is repeated for the replaced sub-input feature map (710 shifted in the opposite direction to the third direction), and when the last row of the input feature map 700 has been completely processed, the sub-weight map 810 is flushed and replaced with a next sub-weight map (810 shifted in the second direction). The above-described process is repeated for the replaced sub-weight map, and operations are performed on the input feature map 700 and the weight map 800.

According to the data flow according to the inventive concepts, locally buffered input feature maps and weight maps are fully reused and replaced only when necessary. Therefore, power consumed for memory access may be reduced. Additionally, by applying an output-fixed approach according to the first operation, power consumption may be reduced by preventing movement of the partial sum. In at least some embodiments, the PE 10 and/or the data flow may be applied to a smartphone performing voice recognition, image recognition, image classification, image processing, etc. by using a neural network, a tablet device, a smart TV, an augmented reality (AR) device, an Internet of things (IoT) device, a self-driving vehicle, robots, a medical device, a drone, an advanced drivers assistance system (ADAS), an image display device, a data processing server, a measuring device, etc. and/or may be mounted in one of various kinds of electronic devices. For example, the voice recognition, image recognition, image classification, image processing, etc. may be based on the output value generated by the PE 10.

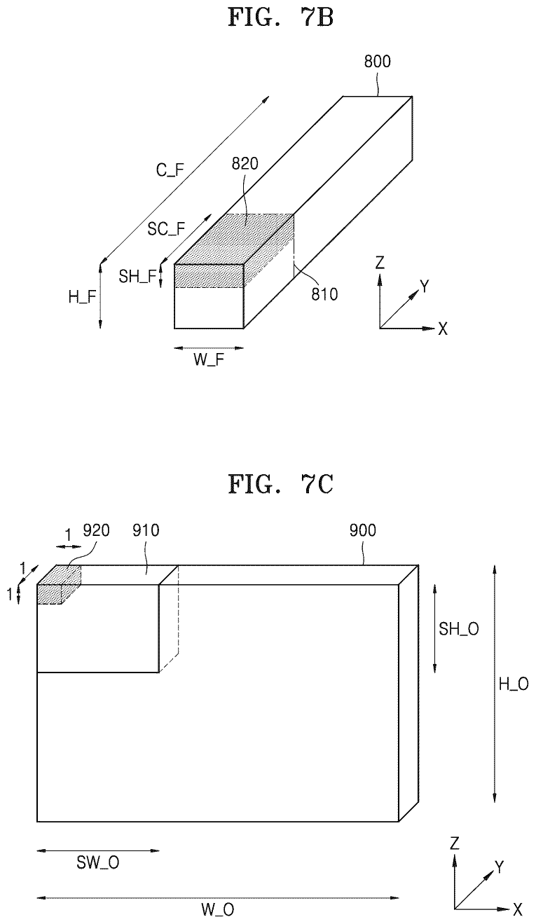

FIG. 8 is a flowchart showing a method of operating a processing circuit, according to at least one embodiment.

Referring to FIG. 8, in operation S100, the processing circuit generates a first compressed chunk including only at least one first valid value, by compressing a first chunk including the at least one first valid value.

In operation S200, the processing circuit generates a first mask that is equal in size to the first chunk, includes a reference value at the same position as a position of the at least one first valid value, and includes a plurality of first sub-masks having the same size.

In operation S300, the processing circuit generates a second compressed chunk including only at least one second valid value, by compressing a second chunk including the at least one second valid value. In other words, the second chunk may be compressed such that the second compressed chunk includes at least one second valid value but not the first valid value. Similarly, the first compressed chunk may be generated such that the first compressed chunk includes at least one first valid value but not the second valid value. In at least some embodiments, the first and second compressed chunks may include only the at least one first and second valid value, respectively.

In operation S400, the processing circuit generates a second mask that is equal in size to the second chunk, includes a reference value at the same position as a position of the at least one second valid value, and includes a plurality of second sub-masks having the same size. In at least one embodiment, the size of the first chunk and the size of the second chunk may be the same.

In operation S500, the processing circuit generates a valid pair position value by searching for a valid pair position including a reference value at the same position of each of the current first sub-mask and the current second sub-mask corresponding to each other.

In operation S600, the processing circuit generates a first cumulative value corresponding to the number of reference values included in at least one first previous sub-mask located before the current first sub-mask.

In operation S700, the processing circuit generates a second cumulative value corresponding to the number of reference values included in at least one second previous sub-mask located before the current second sub-mask.

The processing circuit according to at least one embodiment may generate a first valid position information value that corresponds to a valid pair position value and that corresponds to a position of a first valid value included in a first compressed chunk. The processing circuit according to the inventive concepts may generate a second valid position information value that corresponds to a valid pair position value and that corresponds to a position of a second valid value included in a second compressed chunk.

A processing circuit according to at least one embodiment may generate a first valid position value by adding a first cumulative value and a first valid position information value, and generate a second valid position value by adding a second cumulative value and a second valid position information value.

A processing circuit according to at least one embodiment may generate an output value based on a product of a first valid value included in a first position of a first compressed chunk and a second valid value included in a second position of a second compressed chunk. The first valid position value may correspond to the first position, and the second valid position value may correspond to the second position.

The processing circuit according to at least one embodiment may update the first cumulative value by accumulating, in the first cumulative value, the number of reference values included in the current first sub-mask, and update the second cumulative value by accumulating, in the second cumulative value, the number of reference values included in the current second sub-mask.

In at least one embodiment, a valid pair position value may be less than a size of a current first sub-mask and a size of a current second sub-mask.

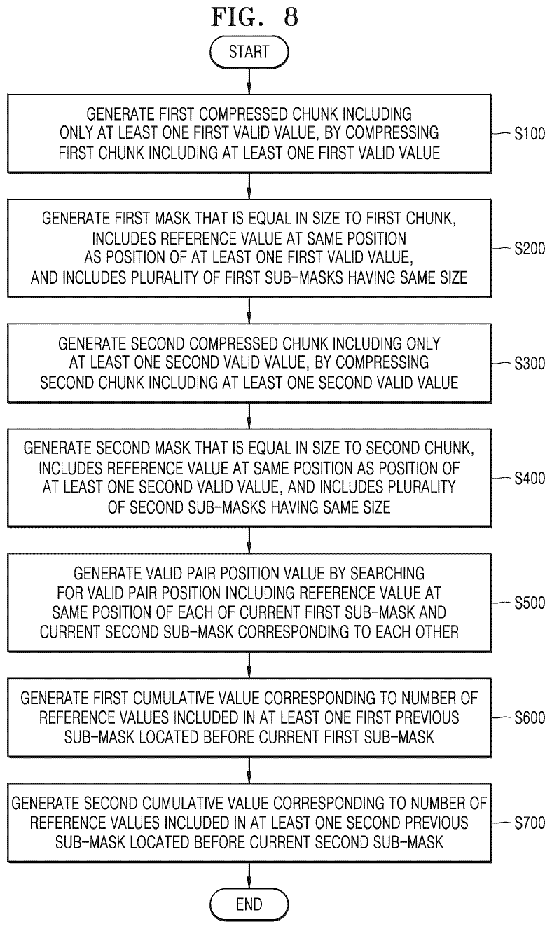

FIG. 9 is a block diagram illustrating a computing system according to at least one embodiment.

In some embodiments, a system including the processing circuit 10 of FIG. 1 may be implemented by a computing system 2000 of FIG. 9. As shown in FIG. 9, the computing system 2000 may include a system memory 2100, a processor 2300, a storage 2500, an input/output devices 2700, and communication connections 2900. Components included in the computing system 2000 may be communicatively connected to each other, for example, through a bus configured to enable one-way and/or two-way and/or broadcast communication with the components with respect to each other and/or exchange and/or receive information. For example, the processor 2300 may be connected to and communicate with the storage 2500, the input/output devices 2700, the communication connections 2900 and/or the system memory 2100 through the bus.

The system memory 2100 may include a program 2120. The program 2120 may cause the processor 2300 to detect valid pair position values according to the embodiments. For example, the program 2120 may include a plurality of instructions that are executable by the processor 2300, and the plurality of instructions included in the program 2120 may be executed by the processor 2300 to thereby detect a position of a valid pair. As a non-limiting example, the system memory 2100 may include volatile memory such as static random-access memory (SRAM) or dynamic random-access memory (DRAM), and non-volatile memory such as a flash memory.

The processor 2300 may include at least one core configured to execute an instruction set (e.g., Intel Architecture-32 (IA-32), 64-bit extended IA-32, x86-64, PowerPC, Sparc, MIPS, ARM, IA-64, etc.). The processor 2300 may execute instructions stored in the system memory 2100 and perform detection of a position of a valid pair by executing the program 2120.

The storage 2500 may be configured to not lose stored data even if power supplied to the computing system 2000 is cut off. For example, the storage 2500 may include nonvolatile memory such as electrically erasable programmable read-only memory (EEPROM), flash memory, phase change random-access memory (PRAM), resistance random-access memory (RRAM), nano-floating gate memory (NFGM), polymer random-access memory (PoRAM), magnetic random-access memory (MRAM), ferroelectric random-access memory (FRAM), etc., and may include storage media such as magnetic tape, optical disk, and magnetic disk. In some embodiments, the storage 2500 may be removable from the computing system 2000.

In some embodiments, the system memory 2100 and/or the storage 2500 may store the program 2120 for valid pair position detection according to at least one embodiment, and before the program 2120 is executed by the processor 2300, the program 2120 (or at least a portion thereof) may be loaded from the storage 2500 into the system memory 2100. In some embodiments, the storage 2500 may store a file written in a program language, and the program 2120 or at least a portion thereof generated by a compiler or the like from the file may be loaded into the system memory 2100. In at least one embodiment, the processor 2300 and/or the system memory may include the processing circuit 10 of FIG. 1 and be configured to perform the method described above based, e.g., on the instructions set.

In some embodiments, the storage 2500 may store data to be processed by the processor 2300 and/or data processed by the processor 2300. For example, the storage 2500 may store a mask and a compressed chunk for the weight map described above.

The input/output devices 2700 may include input devices such as keyboards and pointing devices, and may include output devices such as display devices and printers. For example, a user may trigger execution of the program 2120 by the processor 2300 through the input/output devices 2700.

The communication connections 2900 may provide access to a network external to computing system 2000. For example, a network may include multiple computing systems and communication links, which may include wired links, optical links, wireless links, or any other type of links.

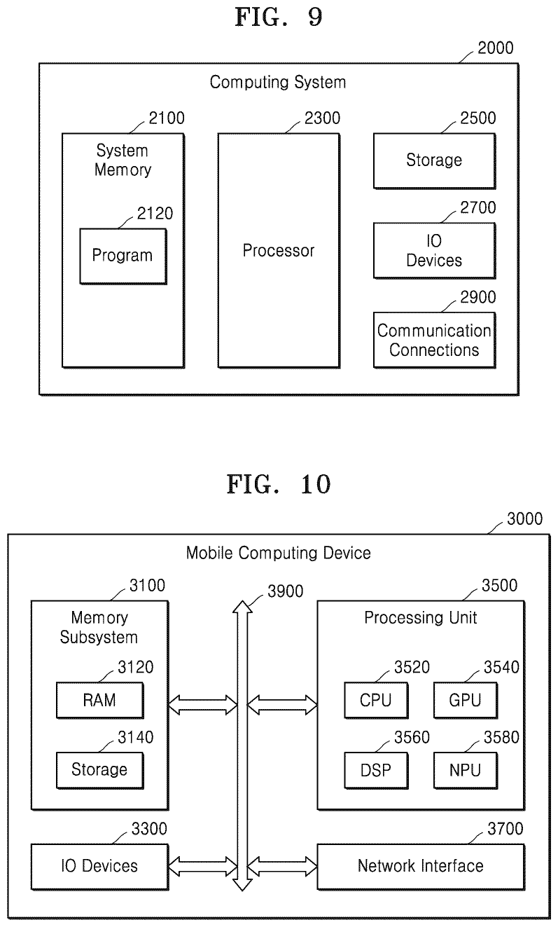

FIG. 10 is a block diagram illustrating a portable computing device according to at least one embodiment.

In some embodiments, valid pair position detection according to at least one embodiment may be implemented in a portable computing device 3000. The portable computing device 3000 may be, as a non-limiting example, any portable electronic device powered by a battery or self-generated power, such as a mobile phone, a tablet PC, a wearable device, an Internet of Things device, etc.

As shown in FIG. 10, the portable computing device 3000 may include a memory subsystem 3100, input/output devices 3300, a processing unit 3500, and a network interface 3700; and the memory subsystem 3100, the input/output devices 3300, the processing unit 3500, and the network interface 3700 may communicate with each other through a bus 3900 configured to enable one-way and/or two-way and/or broadcast communication with the components with respect to each other and/or exchange and/or receive information. In some embodiments, at least two of the memory sub-system 3100, the input/output devices 3300, the processing unit 3500, and the network interface 3700 are system-on-a-chips (SoC) and may be included in one package. In at least one embodiment, the processing unit 3500 and/or the memory subsystem 3100 may include the processing circuit 10 of FIG. 1 and be configured to perform the method described above based, e.g., on an instructions set.

The memory subsystem 3100 may include a RAM 3120 and a storage 3140. The RAM 3120 and/or the storage 3140 may store instructions executed by the processing unit 3500 and processed data. For example, the RAM 3120 and/or the storage 3140 may store variables such as signals, weights, and biases of an artificial neural network, and may store parameters of an artificial neuron (or computational node) of the artificial neural network. In some embodiments, the storage 3140 may include non-volatile memory.

The processing unit 3500 may include at least one of a central processing unit (CPU) 3520, a graphics processing unit (GPU) 3540, a digital signal processor (DSP) 3560, and a neural processing unit (NPU) 3580. In some embodiments, the processing unit 3500 may include only some of the CPU 3520, the GPU 3540, the DSP 3560, and the NPU 3580.

The CPU 3520 may directly perform a specific task in response to the overall operation of the portable computing device 3000, for example, in response to an external input received through the input/output devices 3300, or may instruct other components of the processing unit 3500 to perform the task. The GPU 3540 may generate data for an image output through a display device included in the input/output devices 3300, and may encode data received from a camera included in the input/output devices 3300. The DSP 3560 may generate useful data by processing digital signals, for example, digital signals provided from the network interface 3700.

The NPU 3580 is dedicated hardware for an artificial neural network and may include a plurality of computing nodes corresponding to at least some artificial neurons constituting the artificial neural network, and at least some of the plurality of computing nodes may process signals in parallel. According to at least one embodiment, a quantized artificial neural network, such as a deep neural network, has not only high accuracy but also low computational complexity, and thus, may be easily implemented in the portable computing device 3000 of FIG. 10, and has fast processing speed, and may be implemented, for example, by the NPU 3580 which is of a simple and small scale.

The input/output devices 3300 may include input devices such as a touch input device, a sound input device, and a camera, and output devices such as a display device and a sound output device. The network interface 3700 may provide the portable computing device 3000 with access to a mobile communication network such as Long-Term Evolution (LTE), 5G, etc., or may provide access to a local network such as Wi-Fi.

While the inventive concepts have been particularly shown and described with reference to embodiments thereof, it will be understood that various changes in form and details may be made therein without departing from the spirit and scope of the following claims.

What is claimed is:

1. A processing circuit comprising:
a processing element (PE) configured to generate an output value corresponding to a first chunk and a second chunk that is equal in size to the first chunk, the first chunk including at least one first valid value and the second chunk including at least one second valid value;
a first input circuit configured to provide, to the PE, a first compressed chunk and a first mask that is equal in size to the first chunk, the first mask including a reference value at a position corresponding to the at least one first valid value, and the first compressed chunk including the at least one first valid value; and
a second input circuit configured to provide, to the PE, a second compressed chunk and a second mask that is equal in size to the second chunk, the second mask including a reference value at a position corresponding to the at least one second valid value, and the second compressed chunk the at least one second valid value,
wherein the first compressed chunk does not include the at least one second valid value and the second compressed chunk does not include the at least one first valid value,
wherein the first mask comprises a current first sub-mask, the second mask comprises a current second sub-mask corresponding to the current first sub-mask, and the current first sub-mask and the current second sub-mask include reference values at a same first position, and
wherein the PE is further configured to generate the output value by performing an operation on a first valid value corresponding to a second position of the first compressed chunk and a second valid value corresponding to a third position of the second compressed chunk, wherein the first valid value and the second valid value are selected based on a first valid pair position value corresponding to the first position, and the first valid pair position value is less than a size of the current first sub-mask.

2. The processing circuit of claim 1, wherein the PE is further configured to
generate, based on the first valid pair position value, a first valid position information value for a corresponding reference value included in the first position of the first compressed chunk, and
generate, based on the first valid pair position value, a second valid position information value for a corresponding reference value included in the first position of the second compressed chunk.

3. The processing circuit of claim 2, wherein the first mask further comprises at least one first previous sub-mask located before the current first sub-mask, and the second mask further comprises at least one previous second sub-mask located before the current second sub-mask, and
the PE further comprises
a first adder circuit configured to generate a first valid position value by adding the first valid position information value and a first cumulative value which corresponds to a number of reference values included in the at least one first previous sub-mask; and a second adder circuit configured to generate a second valid position value by adding the second valid position information value and a second cumulative value which corresponds to a number of reference values included in the at least one second previous sub-mask.

4. The processing circuit of claim 3, wherein the size of the current first sub-mask, a size of the current second sub-mask, a size of the at least one first previous sub-mask, and a size of the at least one second previous sub-mask are equal to each other.

5. The processing circuit of claim 3, wherein the first valid position value corresponds to the second position, and the second valid position value corresponds to the third position.

6. The processing circuit of claim 3, wherein the PE further comprises:
a first accumulation circuit configured to generate the first cumulative value by accumulating the number of reference values included in the at least one first previous sub-mask; and
a second accumulation circuit configured to generate the second cumulative value by accumulating the number of reference values included in the at least one second previous sub-mask.

7. The processing circuit of claim 1, further comprising:
a compression circuit configured to compress an input feature map by removing values that are 0 from among a plurality of values included in the input feature map and generate the first compressed chunk and the first mask.

8. A processing circuit comprising:
a processing element (PE) configured to generate an output value corresponding to a first chunk and a second chunk that is equal in size to the first chunk, the first chunk including at least one first valid value and the second chunk including at least one second valid value;
a first input circuit configured to provide, to the PE, a first compressed chunk and a first mask that is equal in size to the first chunk, the first mask including a reference value at a position corresponding to the at least one first valid value, and the first compressed chunk including the at least one first valid value; and
a second input circuit configured to provide, to the PE, a second compressed chunk and a second mask that is equal in size to the second chunk, the second mask including a reference value at a position corresponding to the at least one second valid value, and the second compressed chunk including the at least one second valid value,
wherein the first compressed chunk does not include the at least one second valid value and the second compressed chunk does not include the at least one first valid value,
wherein the size of the first mask is equal to the size of the second mask, and
wherein the PE comprises an accumulation circuit configured to
generate a valid pair position value by searching for positions where reference values are commonly included in each of the first mask and the second mask in units of sub-masks which are smaller in size than the first mask and the second mask, and
generate a cumulative value based on a number of reference values included in a previous region in which a search is completed, among entire regions of each of the first mask and the second mask, and
wherein the PE is further configured to generate the output value by performing an operation on a first valid value and a second valid value selected based on the cumulative value and the valid pair position value.

9. The processing circuit of claim 8, wherein the accumulation circuit is further configured to
generate a first cumulative value corresponding to the number of reference values included in the previous region where the search is completed, among entire regions of the first mask, and
generate a second cumulative value corresponding to the number of reference values included in the previous region where the search is completed, among entire regions of the second mask.

10. The processing circuit of claim 9, wherein the PE further comprises an adder circuit configured to
generate, based on the valid pair position value, a first valid position information value corresponding to a position of a first valid value included in the first mask within the units of sub-masks,
generate, based on the valid pair position value, a second valid position information value corresponding to a position of a second valid value included in the second mask within the units of sub-masks,
generate a first valid position value by adding the first valid position information value and the first cumulative value, and
generate a second valid position value by adding the second valid position information value and the second cumulative value.

11. The processing circuit of claim 10, wherein the PE is further configured to
generate the output value based on a product of a first valid value included in a first position of the first compressed chunk and a second valid value included in a second position of the second compressed chunk, and
wherein the first valid position value corresponds to the first position, and the second valid position value corresponds to the second position.

12. The processing circuit of claim 8, further comprising:
a compression circuit configured to generate the first compressed chunk and the first mask by compressing an input feature map, the compressing the input feature map including omitting values that are 0 from among a plurality of values included in the input feature map.

13. The processing circuit of claim 8, wherein the valid pair position value is less than the units of sub-masks.

14. An operating method of a processing circuit, the method comprising:
generating a first compressed chunk including only at least one first valid value by compressing a first chunk including the at least one first valid value;
generating a first mask that is equal in size to the first chunk, includes a reference value at a same position as a position of the at least one first valid value, and includes a plurality of first sub-masks having a same size as each other;
generating a second compressed chunk including only at least one second valid value by compressing a second chunk including the at least one second valid value;
generating a second mask that is equal in size to the second chunk, includes a reference value at a same position as a position of the at least one second valid value, and includes a plurality of second sub-masks having a same size as each other;
generating a valid pair position value by searching for a valid pair position including corresponding reference values at a same position of each of a current first sub-mask and a current second sub-mask corresponding to each other;
generating a first cumulative value corresponding to a number of reference values included in at least one first previous sub-mask located before the current first sub-mask; and
generating a second cumulative value corresponding to a number of reference values included in at least one second previous sub-mask located before the current second sub-mask.

15. The method of claim 14, further comprising:
generating a first valid position information value corresponding to the valid pair position value and corresponding to a position of the first valid value included in the first compressed chunk; and
generating a second valid position information value corresponding to the valid pair position value and corresponding to a position of the second valid value included in the second compressed chunk.

16. The method of claim 15, further comprising:
generating a first valid position value by adding the first cumulative value and the first valid position information value; and
generating a second valid position value by adding the second cumulative value and the second valid position information value.

17. The method of claim 16, further comprising:
generating an output value based on a product of a first valid value included in a first position of the first compressed chunk and a second valid value included in a second position of the second compressed chunk,
wherein the first valid position value corresponds to the first position, and the second valid position value corresponds to the second position.

18. The method of claim 17, further comprising:
updating the first cumulative value by accumulating, in the first cumulative value, the number of reference values included in the current first sub-mask; and
updating the second cumulative value by accumulating, in the second cumulative value, the number of reference values included in the current second sub-mask.

19. The method of claim 14, wherein the valid pair position value is less than a size of the current first sub-mask and a size of the current second sub-mask.

20. The method of claim 14, wherein the generating of the first compressed chunk comprises compressing an input feature map by removing invalid values from among a plurality of values included in the input feature map and generating the first compressed chunk, and
the generating of the second compressed chunk comprises compressing a weight map by removing invalid values from among a plurality of values included in the weight map and generating the second compressed chunk.
